(19) United States
(12) Patent Application Publication
(10) Pub. No.: US 2013/0310089 A1
(43) Pub. Date: Nov. 21, 2013

(54) VOICE TEXTING OVER SMS

(71) Applicants: Vasileios John Gianoukos, Winchester, MA (US); Eugene Lee Lew, Olney, MD (US)

(72) Inventors: Vasileios John Gianoukos, Winchester, MA (US); Eugene Lee Lew, Olney, MD (US)

(21) Appl. No.: 13/945,453

(22) Filed: Jul. 18, 2013

Related U.S. Application Data
(63) Continuation-in-part of application No. 13/111,109, filed on May 19, 2011.
Application No. 13/111,109 is a continuation-in-part of application No. 12/535,323, filed on Aug. 4, 2009.
(60) Provisional application No. 61/825,558, filed on May 21, 2013.
(60) Provisional application No. 61/473,542, filed on Apr. 8, 2011.
(60) Provisional application No. 61/473,508, filed on Apr. 8, 2011.
(60) Provisional application No. 61/346,133, filed on May 19, 2010.
(60) Provisional application No. 61/137,918, filed on Aug. 5, 2008.
(60) Provisional application No. 61/164,705, filed on Mar. 30, 2009.

(51) Int. Cl. H04W 4/14

(52) U.S. Cl. CPC H04W 4/14
USPC 455/466

(57) ABSTRACT

A social messaging hub provides communication services including voice text messaging for a data enabled device having Internet network access capabilities. A user is given a registered phone number and unique IP addressable identification which serve as a source and destination identifier of the associated data enabled device. Voice text messages are processed, stored and delivered as SMS messages using resources on the social messaging hub and the global SMS infrastructure. Voice text messages may be sent to both subscriber and non-subscriber devices connected to the global SMS infrastructure.

### CROSS REFERENCE TO RELATED APPLICATIONS

This application claims the benefit of U.S. provisional patent application Ser. No. 61/825,558, entitled “VOICE TEXTING OVER SMS”, filed May 21, 2013, This application is continuation in part of U.S. patent application Ser. No. 13/111,109 entitled “SOCIAL MESSAGING HUB” filed May 19, 2011 that shares inventorship with the present application and which is a continuation in part of U.S. patent application Ser. No. 12/535,323 entitled “SMS TECHNOLOGY FOR COMPUTERIZED DEVICES filed Aug. 4, 2009 that shares inventorship with the present application and which claims the benefit of U.S. provisional patent application Ser. Nos. 61/137,918, entitled “Apparatus and methods for TV social applications”, filed Aug. 5, 2008, 61/164,705, entitled “SMS Technology for Computerized Devices”, filed Mar. 30, 2009. This application claims the benefit of the filing date of: of earlier filed U.S. Provisional Patent Application Ser. No. 61/346,133 entitled “SOCIAL MESSAGING SYSTEM AND DEVICES,” filed May 19, 2010 that shares inventorship with the present application, earlier filed U.S. Provisional Patent Application Ser. No. 61/473,508 entitled “SOCIAL MESSAGING SYSTEM,” filed, Apr. 8, 2011, that shares inventorship with the present application. The entire teachings and contents of these patent applications are hereby incorporated by reference herein in their entireties.

### FIELD OF THE INVENTION

The present invention relates to messaging and communications, and to mobile telephony and voice text messaging.

### BACKGROUND

People around the world are confronted by a number of communications and writing devices which have evolved relatively recently from the separate areas of telephone communications networks, wireless networks, television or cable networks, and computer networks and personal computers. The more recent devices—mobile phones with message/picture/video texting, personal digital devices for Internet browsing and computer-based blogging and social networking sites—have been shaped in part by the separate networks of origin, but the nature and capabilities of many of these now-ubiquitous devices have both converged, and also advanced quickly in different directions as the industries controlling each sector have capitalized on their market power, reservoir of legacy subscribers and, in some cases, regulatory barriers and proprietary network equipment and connection protocols, to introduce new consumer features, often employing developments from other consumer products, and aiming to lure subscribers by mimicking those products. However, in doing so, each industry has also been limited by its own equipment, data transfer speeds and connection abilities.

Thus, as digital imaging advanced and consumers learned to take and handle images and to attach the images to e-mail messages, imaging chipsets were incorporated into mobile telephones and the mobile phones were configured to display images and allow their transmission between phones. Text and message protocols allowed transmission of ‘instant’ messages, and coded standardized greetings and messages between phone users, filling a niche for immediate portable, personal communication that was not met by existing personal computer devices. Devices like the iPhone®, introduced in 2007 allowed a user to access his Internet-based email from his mobile phone via a specially-configured data connection with his mobile service provider, and to exchange content via wireless connection to his personal computer.

However, despite these developments blurring boundaries between the classical phone, mobile telephone, Internet, wireless and television or cable networks, there has not been a convergence. Rather, although industry and government groups have promoted interface standards for several different classes of data or communication, each industry has retained much of its special structure, and the devices served by an industry (such as mobile telephones) may find their feature set constrained by intrinsic limitations of bandwidth and connectivity, by available networking equipment base, and by the level of contractual cooperation agreements of its provider. The many different classes of communications systems now available, and the many separate provider networks in each class, have also required the development of new supporting entities, such as nationally- or internationally-extending registries, aggregators, exchanges and other entities, in order to affect timely transfer of data, messages and/or entertainment content. This second-level infrastructure imposes further constraints of the feasible, or economically feasible, set of features that a consumer may exercise. Thus, for example, mobile telephones have been augmented with a display and the ability to run small applications such as games, MP3 players, Internet browsers/applications and email retrieval, while personal computers have the capability to run larger programs, employ wireless connectivity and perform voice-over-IP (VOIP) Internet communications. Various special-purpose applications requiring cross-platform connections may be provided, or applications simulating cross-platform capabilities may be developed, by a service provider, such as a television-displayed chat session available for subscribers of a TV provider. However, many other personal devices while having large data capacity, ability to connect to another user device and ability to run entertainment apps, may entirely lack the mobile telephone electronic circuitry necessary for exchanging mobile messages with telephone users. Additionally, the delivery of messages in some social messaging systems is affected by limitations of carrier networks and international boundaries. It is therefore desirable to provide a system for enhanced communication between personal devices.

Conventional systems implemented by mobile carriers (e.g., Nextel/Sprint, AT&T, Verizon and T-mobile), provide PTT (Push To Talk) solutions. However, these systems use a real time “walkie talkie” capability which inefficiently places demands on both the RF spectrum and network resources. These systems also require the receiving party to be “on-line.”

Conventional systems (e.g., Voxer and WhatsApp) can send voice files to registered subscribers, but cannot communicate with anyone outside of their registered users. These conventional systems cannot send or receive Voice Text messages outside their realm of private users since they do not support SMS and do not have phone numbers assigned to each account.

### SUMMARY OF THE INVENTION

No service provider has provided a voice texting service via SMS. Other services can send voice files to a limited group of subscribers, but they do not provide voice texting via SMS capable of reaching non-subscribers. They can only provide the functionality in a proprietary manner (restricted to their own subscribers). In contrast, embodiments disclosed herein provide voice texting via SMS, enabling any person with a device having SMS capabilities to receive voice text messages. In addition, these embodiments are more efficient than PTT walkie talkie solutions because these embodiments utilize the global SMS infrastructure and employ a Store-and-Retrieve model which does not have to operate in real-time.

Enhanced communication between personal devices is achieved in accordance with one aspect of the invention by a system for communication with a data enabled device although lacking mobile phone hardware and software, includes Internet network access capabilities. Such data enabled devices include, but are not limited to, an iPod touch®, iPad®, portable e-Reader, a personal computer, a portable game player, a game console, a laptop, a television settop receiver, a television set, tablet or a netbook computer. The user of a non-telephony data enabled personal electronic device or a data enabled telephony device (e.g., smartphone, iPhone) is given a registered phone number (or an additional phone number for data enabled telephony devices) which serves to identify the source device in messages originating from the user of service on the data enabled device. The phone number also serves to indicate destination in messages directed to the user of the service on the non-telephony data enabled device. Such messages may originate in mobile telephones of other users, or in similarly equipped and provisioned non-telephony or telephony data enabled devices of other users. A social messaging hub operates such that incoming mobile text messages/multi-media messages are transparently routed, locally or internationally, through existing Short Message Service/Multimedia Messaging Service/Enhanced Messaging Service SMS/MMS/EMS messaging infrastructures including messaging aggregation and delivery organizations, thus messaging bi-directionally between mobile phones and the user's non-telephony data device or smartphone. Communication in situations where typing is not possible (e.g., while driving) and viewing a standard SMS text message is distracting (e.g., while driving), listening to a received SMS message when reading is not possible (e.g.—while driving) is enabled by using speech in a voice text as opposed to reading and typing a conventional text message.

In one embodiment, a technique for messaging communications with a data enabled device includes obtaining a plurality of unique identifiers, assigning to a user of the data enabled device a unique identifier from the plurality of unique identifiers, associating the unique identifier with a data enabled device identifier and registering the unique identifier to data enabled device identifier association in a database. The technique further includes, receiving a voice text from the data enabled device including a SMS destination identifier for the voice text, processing the voice text to store an audio file in audio storage, generating an SMS message with a link to the audio file and providing the SMS message to a message service for delivery to a message recipient indicated by the SMS destination identifier. Such a technique enables some people who prefer ‘talking/listening’ for messaging versus typing to send text messages. Certain embodiments take advantage of the voice command intelligent capabilities of smartphones, and higher-end feature phones (dumb smartphones). Other embodiments enable people to more safely send and receive SMS text messages in situations where they cannot or should not be typing, such as driving an automobile.

In other embodiments, the technique further includes providing the SMS message to an online social networking service for delivery to at least one subscriber of the online social networking service, an online discussion forum for to at least one subscriber of the online discussion forum service and further including providing the SMS message to an online microblogging service for to at least one subscriber of the online microblogging service.

Indeed, all subscriber messages are transmitted over the Internet through one or more servers and a message aggregation entity in the messaging infrastructure, so the entire service may be set up as a small third party or outside NUVO, or as similarly small Internet-coupled server operation within an existing mobile carrier (or land-line) network. When offered by an existing mobile carrier to a subscriber with an existing mobile phone, the system enables a user to additionally log onto a web-based service to send and receive SMS/MMS messages with his PC or other data enabled device. Such a web-based service may also operate to send and receive messages identified by a user's land line phone number, even if the user's land line/fixed phone is not SMS/MMS/EMS capable. The social messaging hub may be configured to exchange user messages with common messaging entities, such as Microsoft Windows Live Messenger, AIM, Yahoo, GoogleTalk™, Twitter, Facebook and others, so that texting mobile phones and non-telephony data devices can enjoy substantially similar messaging capabilities. When offered by an existing mobile carrier to a subscriber with an existing mobile phone, the system enables a user to additionally use a secondary phone number simultaneously with his primary phone number to send and receive SMS/MMS/EMS messages with his mobile phone, in essence providing a duality of identifications on a single device.

An exemplary social messaging hub for Short Message Service/Multimedia Messaging Service/Enhanced Messaging Service (SMS/MMS/EMS) communications includes a hub application operating on a web server, a voice text processing engine coupled to the hub application, an SMS provider, an audio storage subsystem coupled to the voice text processing engine and an SMS provider coupled to the voice text processing engine and to a global SMS infrastructure. In other aspects of the social messaging hub, the data push server includes an interface to a push notification server, a notification queue, and a queue listener. Another aspect of the social messaging hub, the messaging hub includes a common message conversation queue. Such a system enables input creation of non-Latin or foreign language messages on Western language devices (e.g.—English default mobile phone & keyboard). Voice texts can be sent via SMS in Chinese using the SMS address of recipient, even if the recipient resides in China by using a telephone number with only the numeric characters 0-9.

Advantageously the social messaging hub runs software for converting messages into the different formats and employed in each of the foregoing messaging environments, and may include software for filing and maintaining all the text/multi-media messages of a user for later or simultaneous access, transmission or retransmission to the user's blogs, Facebook and other contacts. The social messaging hub allows a user to send one message across several social networks via text messaging, instant messaging (1M) and other Internet protocol (IP) based messaging formats to multiple contacts in one operation.

A data enabled device (also referred to as the Wi-Fi/mobile device) having dual mode Internet network access capabilities operates with software to optimize cost and to efficiently display content or effect communications when traveling internationally away from a home locale or when using a limited data transmission plan. Internal software controls SMS transmission so as to minimize international text messaging charges, and preferably also establishes Internet connection via Wi-Fi connection for accessing content, such as advertising content, appearing on the device's display. For use in a foreign country, the device may be fitted with a SIM card of the foreign country carrier (a local SIM card) and operate as a normal mobile phone to receive local calls, while it is configured to automatically send SMS messages via Wi-Fi, or using data capabilities associated with the data local SIM card when Wi-Fi connectivity is unavailable.

Embodiments of the invention include any type of computerized device, workstation, handheld, tablet or laptop computer, or the like configured with software and/or circuitry (e.g., a processor) to process any or all of the method operations disclosed herein. In other words, a computerized device or a processor that is programmed or configured to operate as explained herein is considered an embodiment of the invention.

Other embodiments of the invention that are disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor and a display, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein. Other configurations include web applications, browsers, IP applications and data enabled device applications as will be explained in more detail.

It is to be understood that the features of the social messaging hub can be embodied strictly as a software program, as software and hardware, or as hardware alone such as within a single processor or multiple processors, or within an operating system or within a software application.

### BRIEF DESCRIPTION OF THE DRAWINGS

The foregoing and other objects, features and advantages of the invention will be apparent from the following more particular description of embodiments of the invention, as illustrated in the accompanying drawings and figures in which like reference characters refer to the same parts throughout the different views. The drawings are not necessarily to scale, with emphasis instead being placed upon illustrating the embodiments, principles and concepts of the invention. These and other features of the invention will be understood from the description and claims herein, taken together with the drawings of illustrative embodiments, wherein:

FIG. 1 is a block diagram of a system for voice texting over SMS according to embodiments herein;

FIG. 2 is a schematic illustration of a social messaging hub and network environment/messaging infrastructure in accordance with one example embodiment disclosed herein;

FIG. 3 is a schematic illustration of the social messaging hub of FIG. 1 including an embodiment of a system configured for voice text messaging;

FIG. 4 illustrates details an embodiment of the social messaging hub of FIG. 2 configured for voice text messaging via SMS;

FIG. 5 is a flow chart of processing steps performed to register data enabled devices and to send voice text messages from these devices to mobile phones through a messaging infrastructure in accordance with embodiments disclosed herein;

FIGS. 6A-6I show screen shots of a user interface involved in a process of sending a voice text message in accordance with one example embodiment disclosed herein; and

FIG. 7 shows a screen shot of a user interface involved in a receiving and playing the voice text message as created by the user interface of FIGS. 6A-6I.

### DETAILED DESCRIPTION

A social messaging hub combines connectivity to the global SMS infrastructure and IP connectivity to data enabled devices to provide “Voice Texting over SMS” a new service not offered by any other service provider currently. Voice Texting over SMS enables a user who either cannot type/read SMS messages at a given moment or chooses to send and receive SMS message via voice.

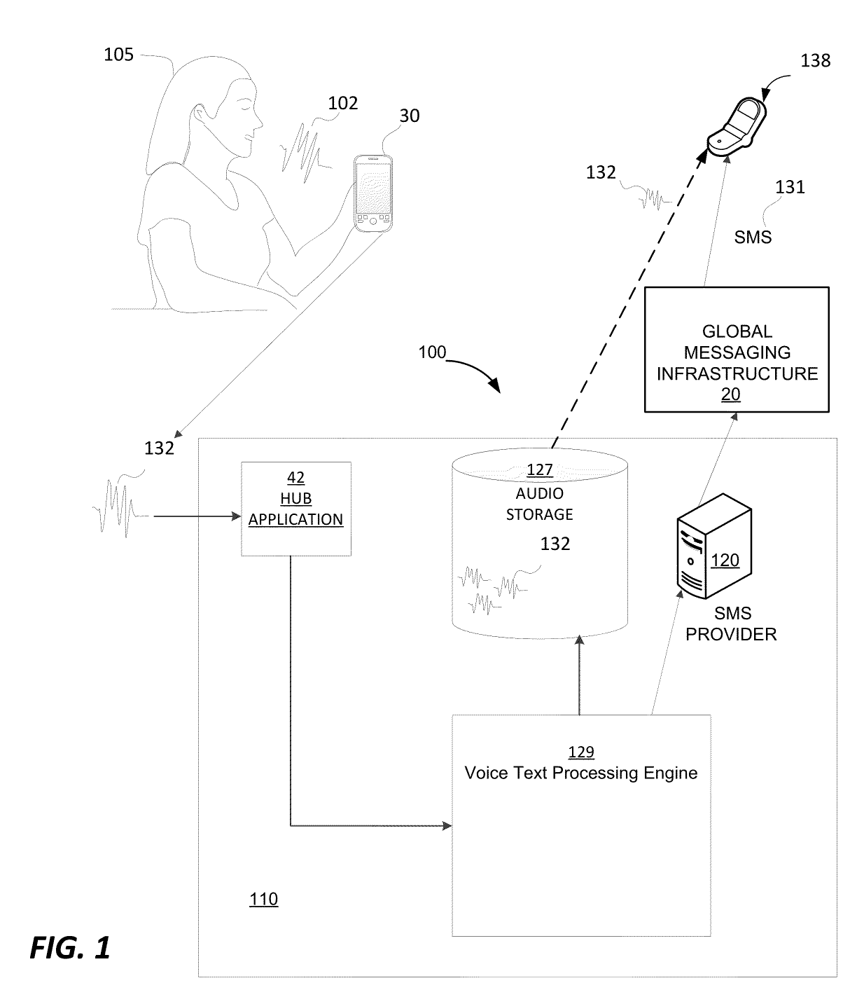

Referring now to FIG. 1, a block diagram illustrates a general architecture of the system and process. Input to the system is a voice text message 102 issued by a speaker 105 (i.e., user), typically captured by a mobile device 30 (also referred to as data enabled device 30). The speaker could be a caller of a mobile telephone, operator of a desktop computer, driver operating a vehicle computer system, user of a wireless tablet computer, etc. In response to the mobile device 30 capturing voice text message, this voice text message along with addressee information is transmitted to a social messaging hub 100, which can be a remote server or similar device. The social messaging hub 100 includes a hub application 42 operating on a web server 110, a voice text processing engine 129 coupled to the hub application, an audio storage subsystem 127 coupled to the voice text processing engine 129 and an SMS provider 120 coupled to the voice text processing engine and to a global SMS infrastructure 20.

Voice text message processing includes receiving the voice text message 102. The speech is converted to a file in an audio format. Formats include but are not limited to: MP3 (MPEG-3 of the Moving Pictures Experts Group), WAV (Microsoft and IBM developed format), AAC (Apple Audio Code format) or any other number of industry standard audio file formats. In one embodiment the file can be encrypted.

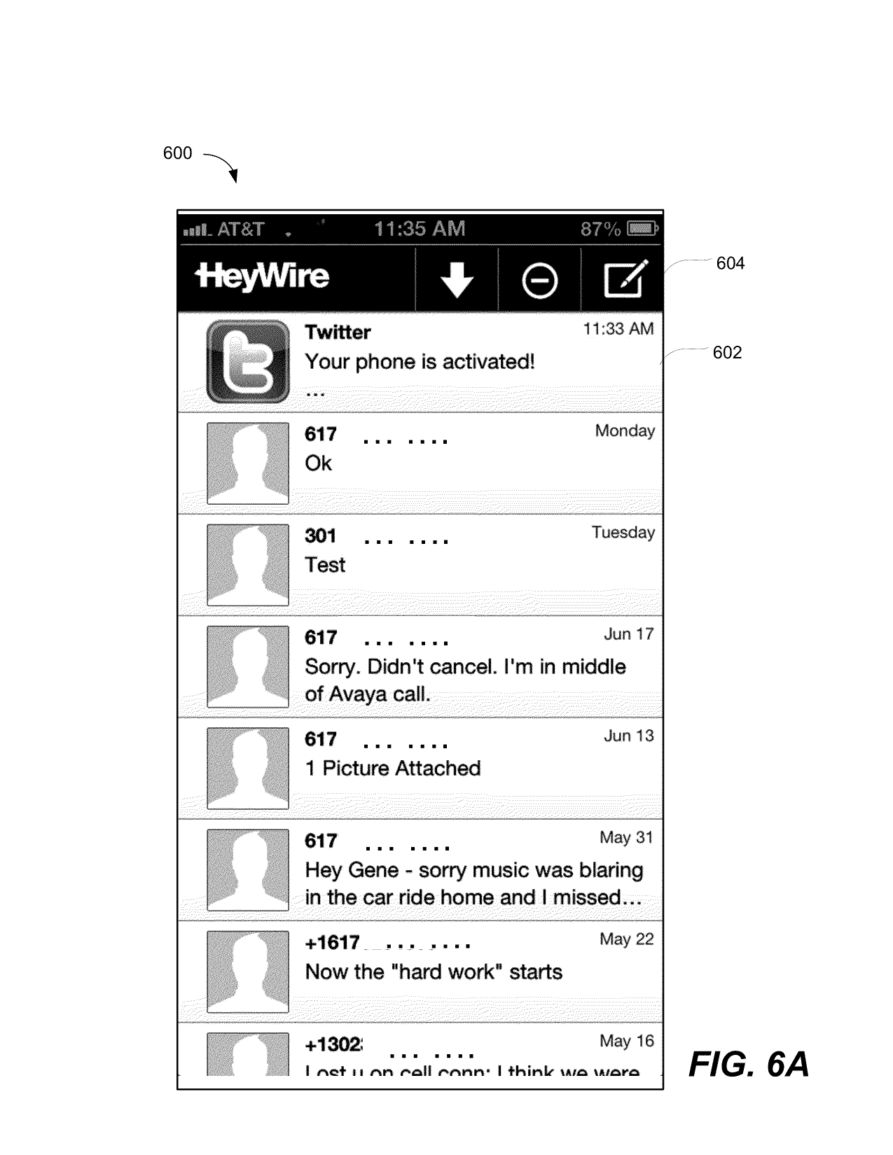

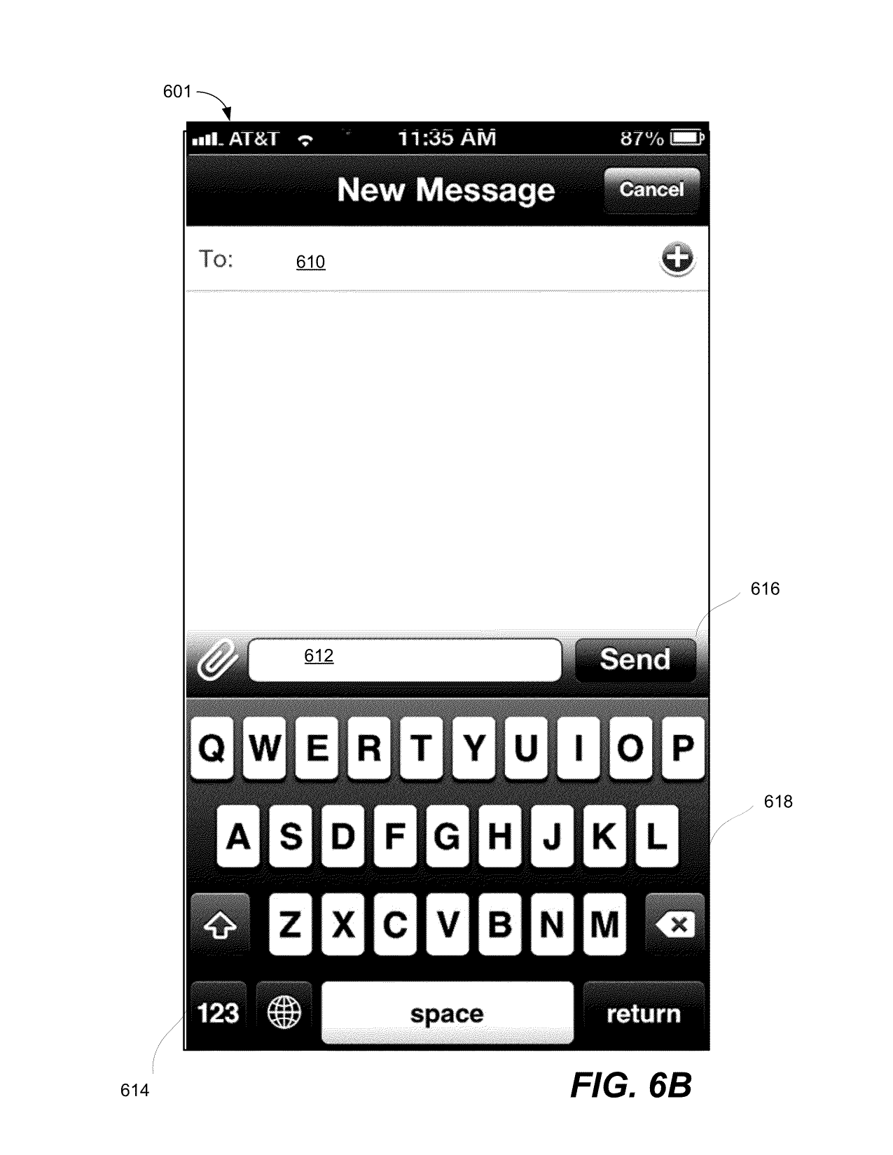

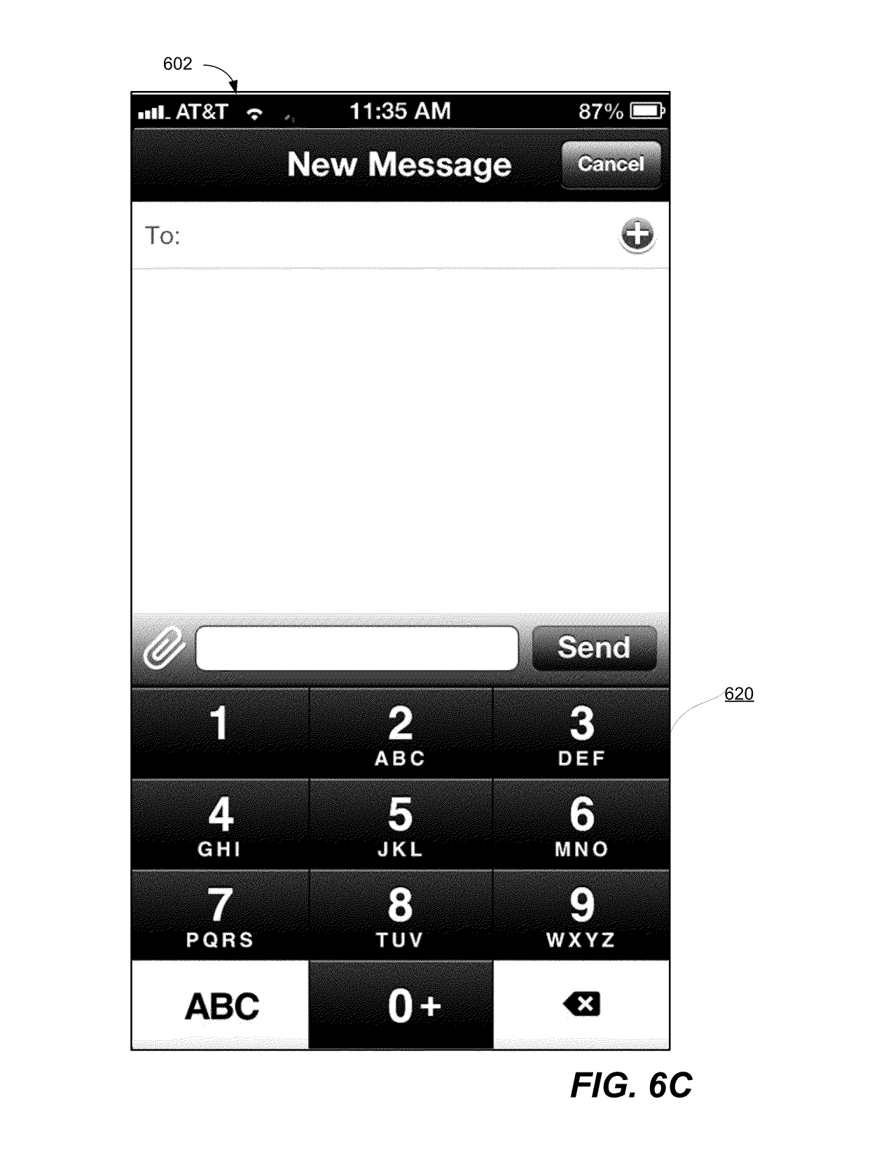

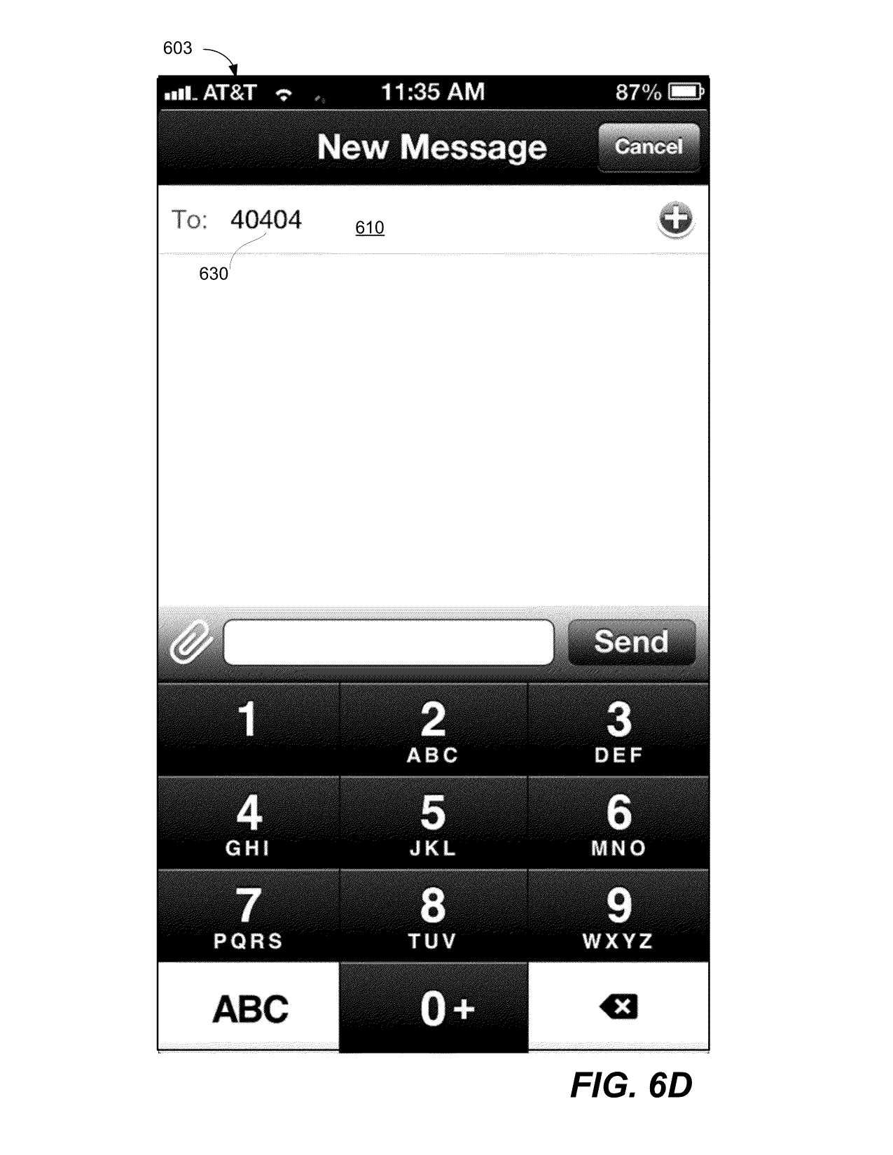

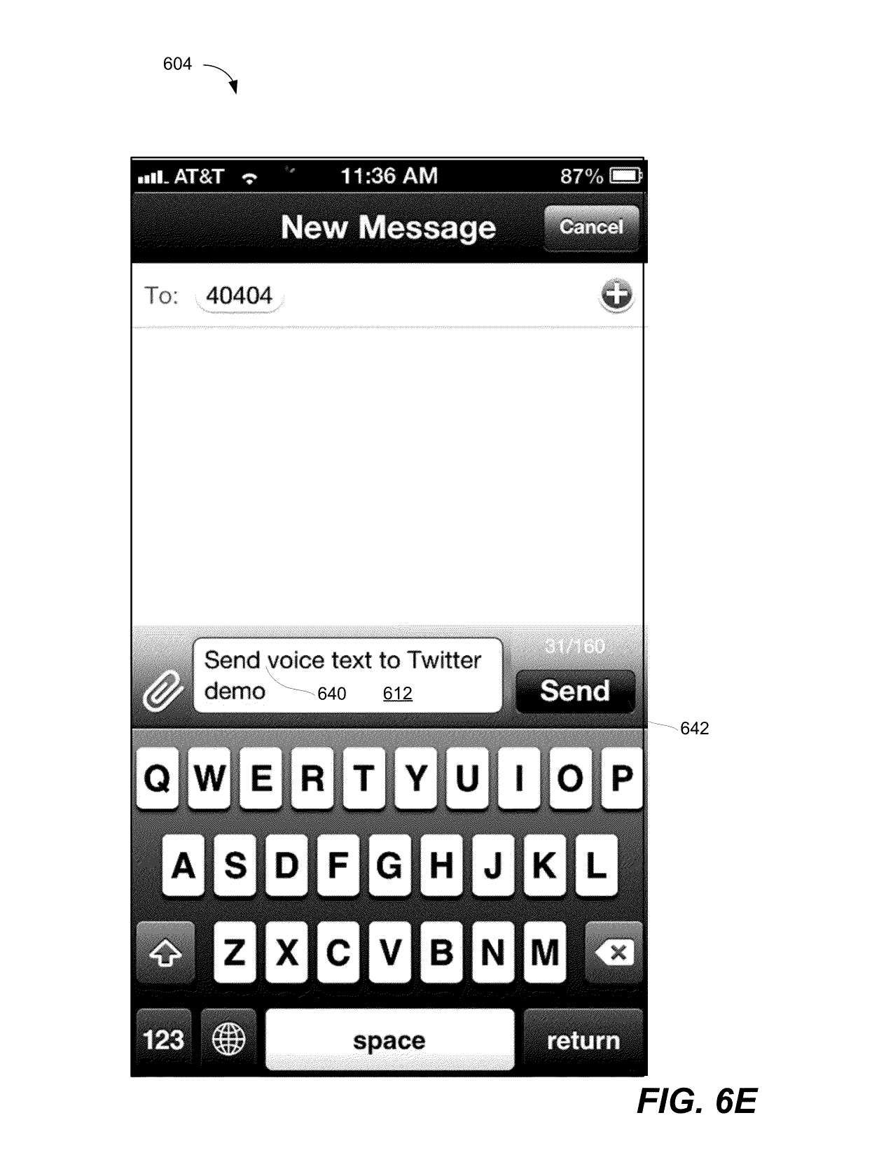

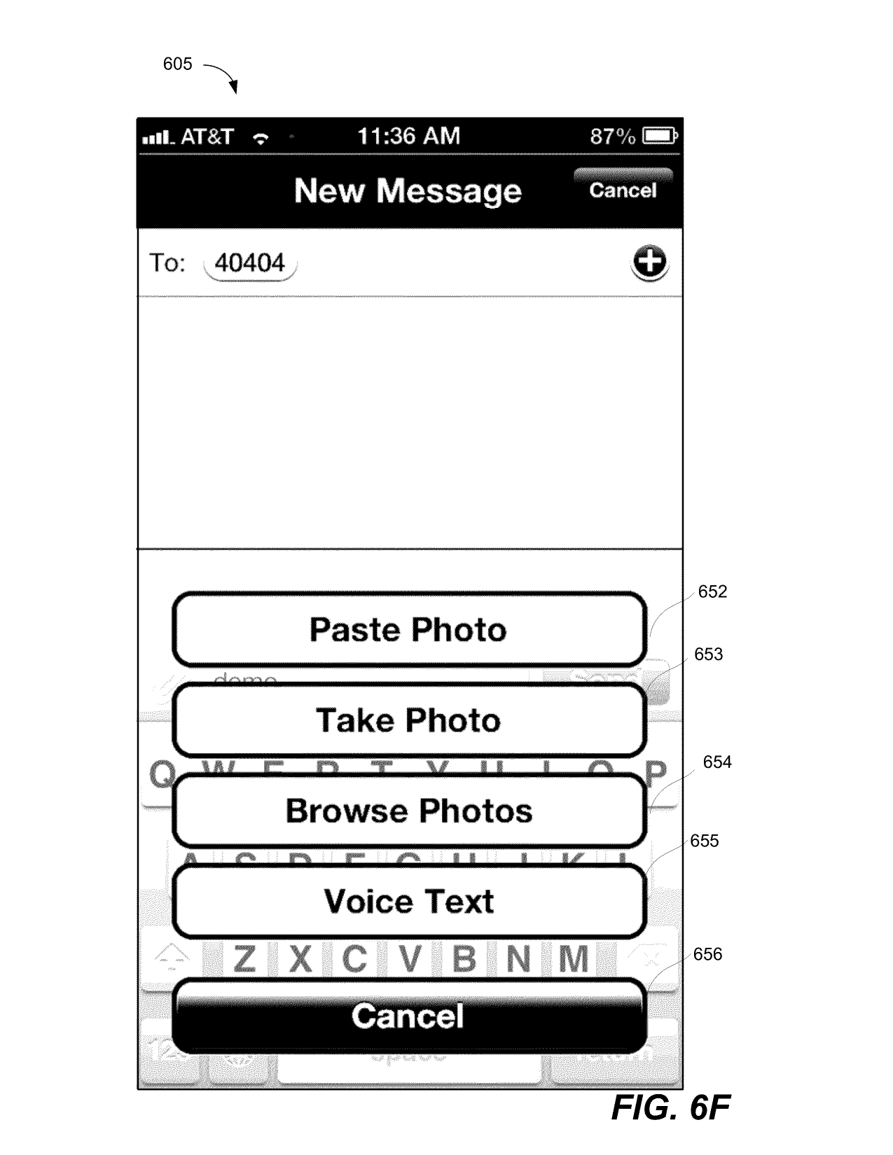

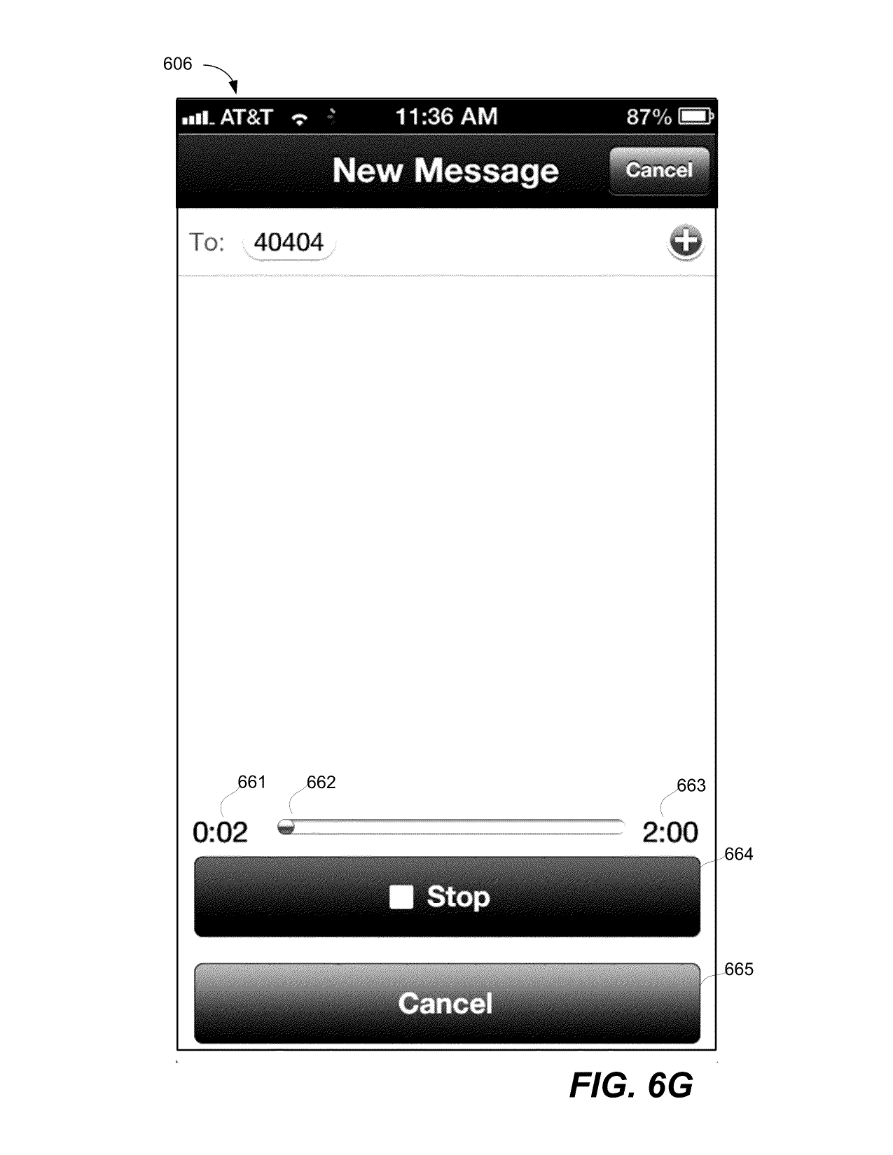

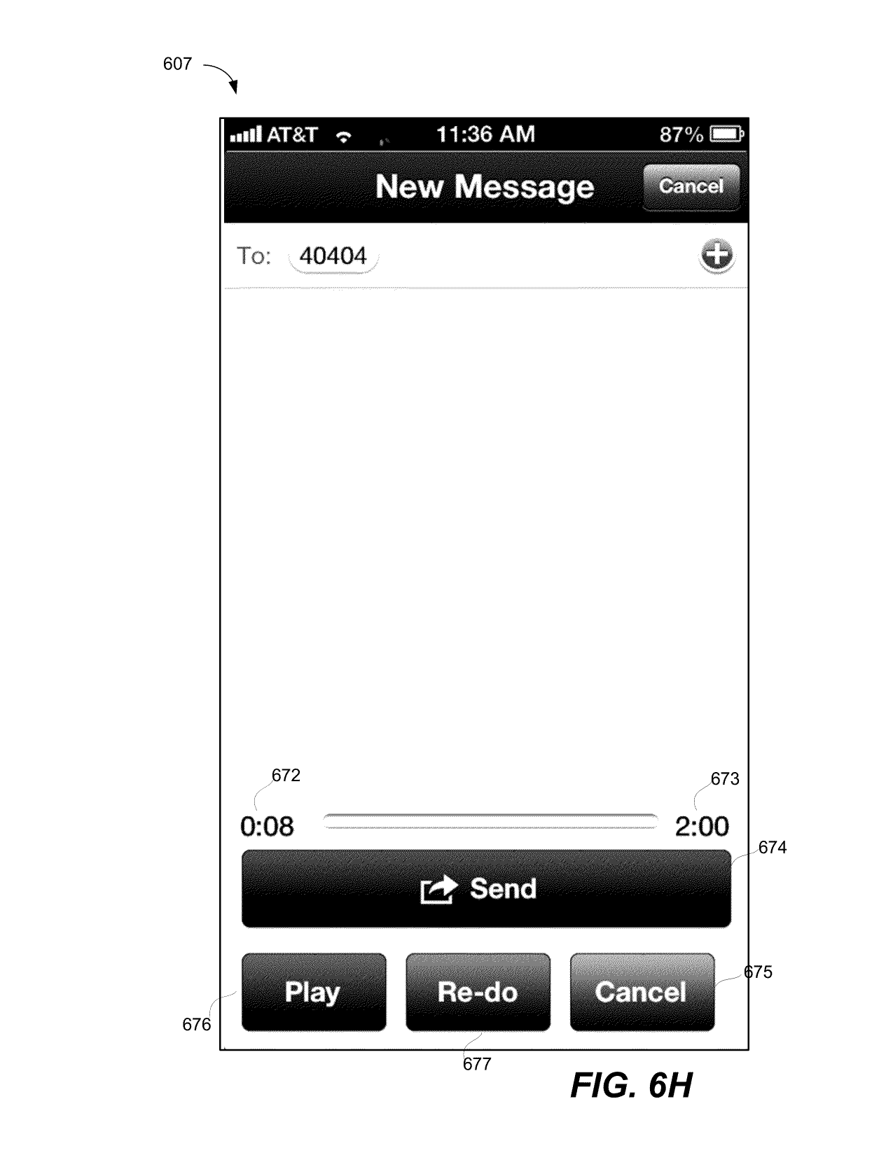

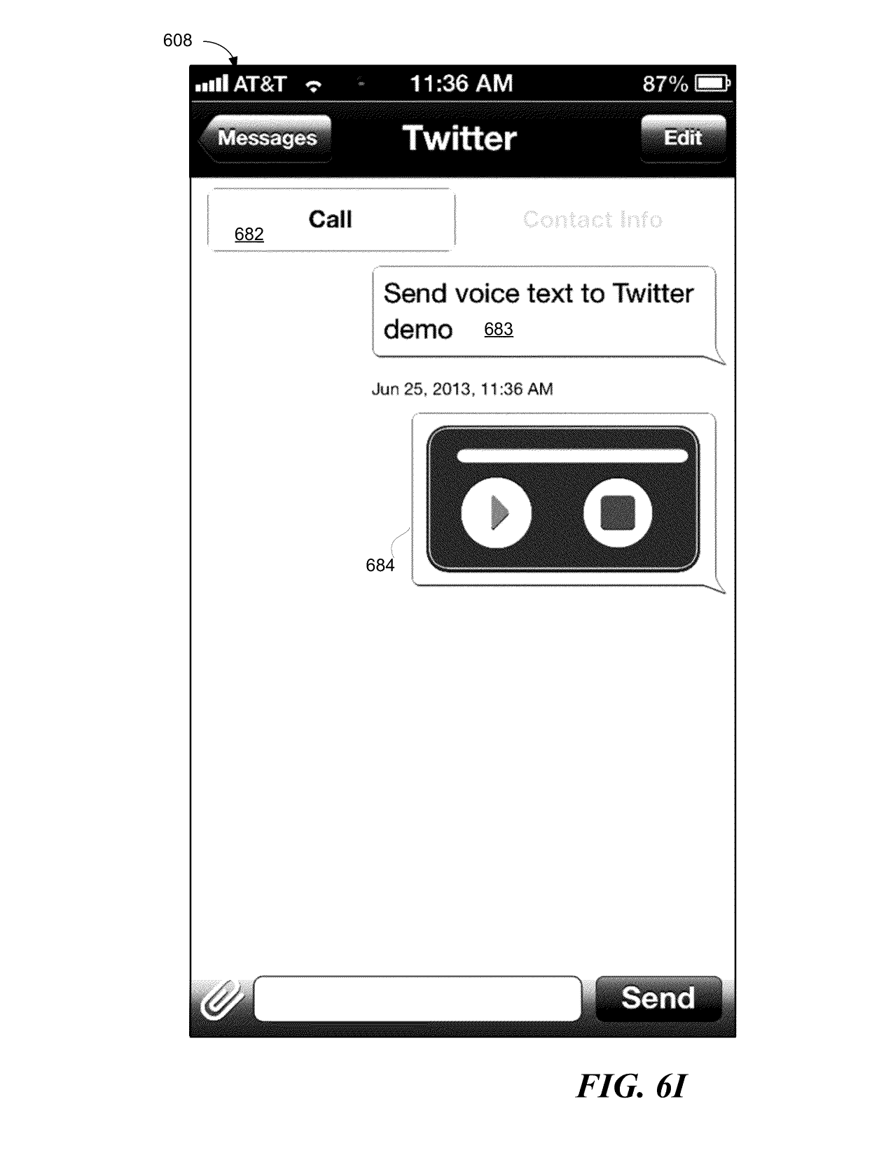

In operation in one embodiment, the user 105 selects a button on an App screen to compose a voice text message via SMS. The user 105 then speaks the voice text message 102 to be sent. The user 105 also enters a phone number (e.g., +cc xxx-xxx-xxxx) associated with the intended recipient of the voice text message before or after speaking the message. The operation of the App is described in more detail below in conjunction with FIGS. 6A-6G. It is understood that user commands can be entered in several ways, for example, spoken voice commands, buttons, touch screen or other input device on the data enabled device 30.

A resultant audio file of the voice text message audio file 132 (e.g., MP3, WAV, etc.) which is generated from the spoken voice text is sent to servers of the social messaging hub 100 and stored in audio storage 127. It is understood that the audio file of the voice text message audio file 132 could be stored on servers of the social messaging hub 100 or in a Cloud storage system 127 coupled to the social messaging hub 100. The intended recipient phone number can be stored with the audio file of the voice text message audio file 132 and/or in another database.

In one embodiment the audio file 132 is encrypted while being stored on servers of the social messaging hub 100 or in the Cloud storage system 127. The audio file 132 is only decrypted in response to a request providing a unique link to the audio file 132. It is understood that other conventional encryption methods (e.g., public key, etc.) can be used to encrypt the audio file 132 or that the audio file 132 can remain unencrypted. In one embodiment, the audio file 132 is retained for a variable period of time (e.g., a week) depending on storage resources and level of service.

An SMS text message 131 is then sent to the intended recipient using the destination identifier provided along with the original voice text message 102. On receiving the SMS text message 131, the recipient user selects a button on APP message screen to ‘play’ or ‘listen to’ the audio Voice Text message audio file 132. The audio file 132 for the Voice Text is retrieved from the audio storage 127 (e.g., cloud storage). The voice text message audio file 132 is then played over the data enable device's 138 sound system (e.g., speaker, ear piece, etc.). The voice text message audio file 132 can also be replayed on the mobile device 30 of the speaker 105. In addition to delivering a link to the voice text message audio file 132, the link can be provided via an SMS message to an online social networking service for delivery to at least one subscriber of the online social networking service or the link can be provided via an SMS message to an online microblogging service for to at least one subscriber of the online microblogging service.

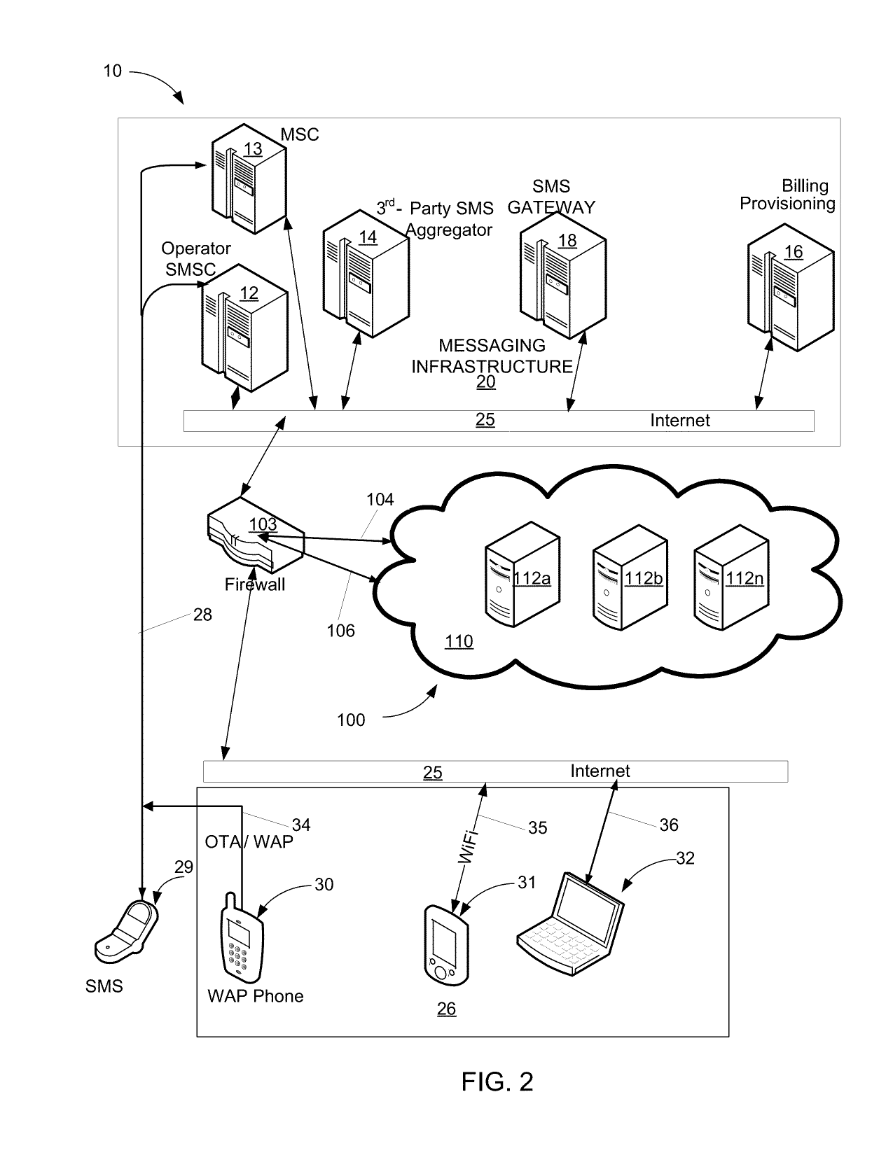

Now referring to FIG. 2, an exemplary social messaging hub 100 operates in network environment 10 which includes messaging infrastructure 20. The social messaging hub 100 includes one or more processors 112a-112n and is coupled to the network environment 10 and messaging infrastructure 20 through a firewall 103. The firewall 103 is typically located at a social messaging hub 100 hosting facility.

The messaging infrastructure 20 includes, but is not limited to, a Short Message Service Center (SMSC) 12, a third party SMS aggregator 14 (also referred to a SMS aggregator 14), a billing and provisioning system 16, an SMS Gateway (SMS-GW) 18, social messaging gateways 22 and a cellular phone infrastructure 28. Other components of the messaging infrastructure 20 include a Mobile Switching Centre (MSC) 13 and additional SMS-Gateways and other SMSCs and billing and provisioning systems provided by additional mobile carrier service providers (not shown). The SMSC 12 and the billing and provisioning system 16 are typically operated by a mobile carrier service provider. The MSC 13 is also typically operated by a mobile carrier service provider. The social messaging gateways 22 include connections to IM services, for example AOL instant messenger (AIM), Yahoo Messenger, Windows Live Messenger Jabber, Skype, Tencent QQ, ICQ and GoogleTalk (gTalk), and other social networks such as Facebook and Twitter.

In one embodiment, the social messaging hub 100 communicates with the systems in the messaging infrastructure 20 (e.g., SMSC 12, the third party SMS aggregator 14 and the billing and provisioning system 16) using various network protocols including the Short Message Peer-to-Peer (SMPP) protocol, Signaling Transport (SIGTRAN) protocol or SS7 protocol. The SMPP protocol is a telecommunications industry protocol for exchanging SMS messages between SMS peer entities.

In this embodiment, the link between the social messaging hub 100 and the messaging infrastructure 20 is secured by the firewall 103 using, for example, a virtual private network (VPN) connection with HTTPS using 1024 bit (3DES-SHA1) encryption. Messages are transferred over SMPP link 104 and provisioning and single sign on (SSO), XML and SOAP messages and other control traffic are interchanged over control link 106. In another embodiment, messages are transferred over SIGTRAN (SS7 over IP) depending on the connection (e.g., a connection to a European Mobile Operator).

The social messaging hub 100 is connected via the Internet 25 or a dedicated connection to the messaging infrastructure 20 that relays messages between existing customer equipment, for example, a mobile phone 29, a data enabled mobile phone 30, a data enabled WiFi phone 31 and other data enabled devices (not shown) such as a laptop, netbook, tablet and a smart phone. The mobile phone 29 can be connected to the social messaging hub 100 over the cellular phone infrastructure 28 through the SMSC 12 using an SMS protocol. The MSC 13 is also connected to the cellular phone infrastructure 28. The data enabled mobile phone 30 can be connected to the social messaging hub 100 over the cellular phone infrastructure 28 using a data connection provided by OTA/WAP protocols. A data enabled WiFi phone 31 can be connected to the social messaging hub 100 via a WiFi connection to the Internet. It is understood that a mobile phone can be data enabled via both a WAP connection and a WiFi connection. The data enabled WiFi phone 31 is sometimes referred to as a dual mode phone if it can also connect over WAP. As referred to herein, a “non-telephony” device is a data enabled device which does not incorporate mobile phone hardware and software and which sends and receives SMS messages over an IP channel in contrast to mobile phone 29 which sends and receives SMS messages over standard cellular phone control channel.

A laptop personal computer 32 can be connected to the social messaging hub 100 via a wired Internet 25 connection 36 or a wireless Internet connection (not shown). Other mobile/portable data enabled devices (not shown) include but are not limited to a portable media players, personal digital assistants, Wi-Fi mobile platforms, pad-tablet computers, portable e-Readers, personal computers, portable game players, game consoles and netbook computers which can be connected to the social messaging hub 100 via the Internet 25 using a WiFi, wired or other wireless connection. These devices, the data enabled mobile phone 30 and the data enabled WiFi phone 31 are collectively referred to as a data enabled device 26 or devices 26 and these devices generally establish an Internet protocol (IP) session or connection with the social messaging hub 100. Some data enabled devices 26 interface with the social messaging hub 100 using a client browser 37 and other data enabled devices 26 interface with the social messaging hub 100 using a client software component (also referred to as a client application or simply “app”). The client browser 37 communication to a corresponding web application and the client application (app) are collectively referred to as application 40. In one embodiment the application 40 (also referred to as a social messaging application or App) is a HeyWire App an application supplied by MediaFriends Inc. and referred to as HeyWire App 40 or simply HeyWire.

In operation and as described below in more detail, the social messaging hub 100 obtains a plurality of unique identifiers which in one embodiment, are telephone numbers acquired through or serviced by a competitive local exchange carrier (CLEC), local exchange carrier (LEC) or other provider that is authorized to issue or service registered phone numbers, and the set of numbers so issued may be serviced by that carrier's network, another carrier network or by a separate entity or sub-entity such as a network unaffiliated virtual operator (NUVO), that serves as the service provider to users and functions as a destination carrier to receive messages directed to its telephone numbers from the SMS aggregator 14, an SMS operator (e.g., a mobile carrier), a content provider or another NUVO, and to provide an Internet interface for delivery of the messages to users' data enabled devices 26.

The social messaging hub 100 assigns a user of a data enabled device 26 a unique identifier from the plurality of unique identifiers and the social messaging hub 100 associates the unique identifier with a data enabled device identifier. The data enabled device identifier includes but is not limited to a network address, a Unique Device Identifier (UDID), a Media Access Control address (MAC address), a International Mobile Equipment Identity (IMEI), a Mobile Equipment Identifier (MEID), a Electronic Serial Number (ESN) and a CPU serial number, of the data enabled device 26. The social messaging hub 100 registers the association between the unique identifier with a data enabled device identifier in a database. After the user is assigned a unique identifier, a userid and password is when the application 40 is started. When the user registers the enabled device 26 and signs-in to an IM service or social media account (e.g., AIM, Yahoo Messenger, Windows Live Messenger and GoogleTalk, Facebook, Twitter, etc.) the account information is stored, in certain embodiments, on the user's data enabled device in a mini database for app. Previously stored login/signon information can be retrieved in order to sign on the user automatically.

In one embodiment, the user is given a registered phone number and unique IP addressable identification. The IP addressable identification is a connectionless method by which the user supplied email address, supplied as part of the registration process for contact purposes, is combined with the unique registered phone number. By affecting such a combination of two unique identifiers, each supplied by separate parties, a unique identification is created that can be located in a connectionless manner on the Internet.

For inbound messages (i.e., sent to the data enabled device 26), the social messaging hub 100 receives the text message from the messaging infrastructure 20 (e.g., message service SMSC 12, or SMS aggregator 14). The message is directed to the user's data enabled device 26 having the registered unique identifier obtained from the text message source, and the social messaging hub 100 provides the message to an inbound service, establishes a connection between a data enabled device 26 and the inbound service and pushes the text message from the inbound service to an application or web browser running on the data enabled device 26.

For outbound messages (i.e., sent from the data enabled device 26). the social messaging hub 100 receives the text message from the data enabled device 26 including a destination identifier for the message, processing the message and provide the message to SMS destination through the messaging infrastructure 20 (e.g., SMSC 12, or SMS aggregator 14) for delivery to the message recipient.

The social messaging hub 100 can submit multiple messages in one transmission using a 1 to many feature in conjunction with the application 40 (i.e., web client or smart phone app). The social messaging hub 100 transfers messages between data enabled devices 26 without the use of the message infrastructure 20 even if phone numbers are used as the addresses. Provisioning and SSO are incorporated in the social messaging hub 100 such that once a registered phone number and other user information is stored in database 126 connections and logins can be established automatically.

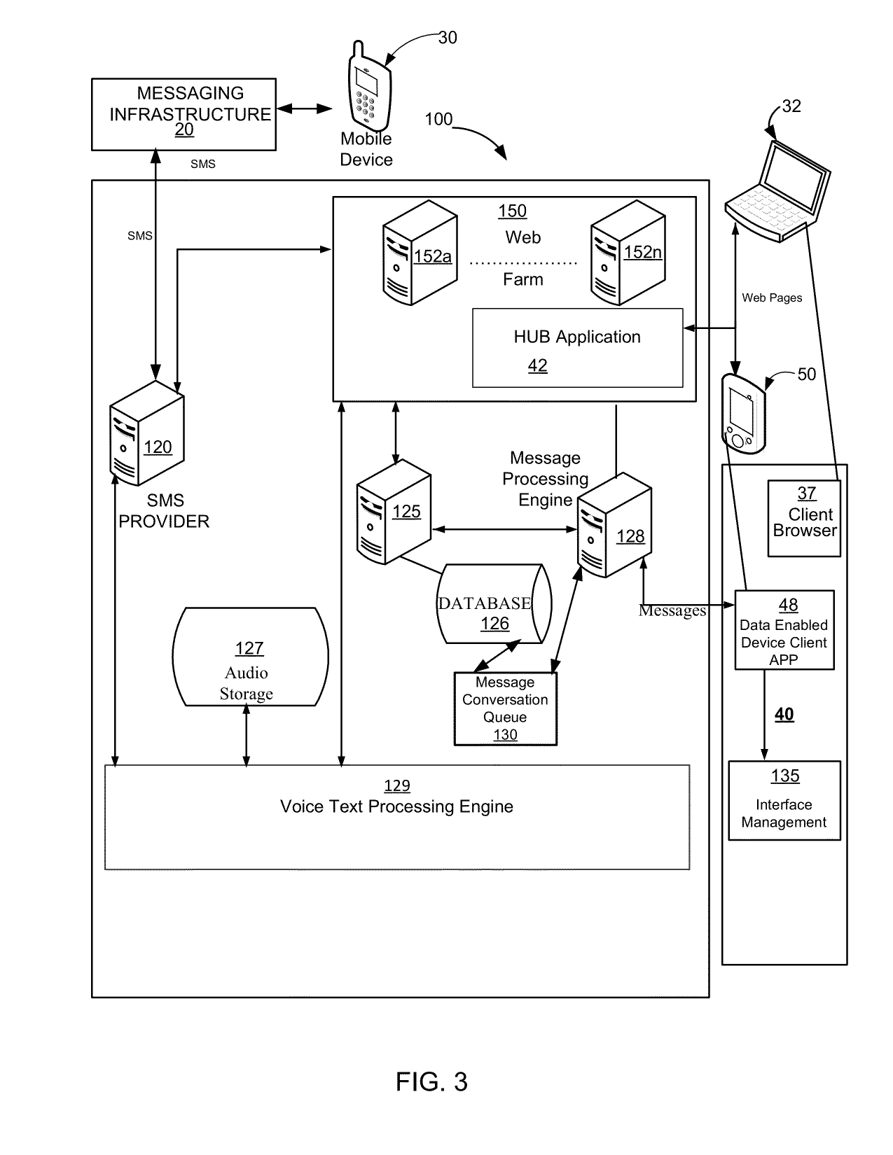

As described below in conjunction with FIGS. 3-5, the social messaging hub 100 may be configured to provide voice texting services using SMS/MMS-capable mobile phones and smart phones, and operates such that incoming mobile voice text messages are transparently routed, locally or internationally, through existing SMS/MMS delivery organizations in the messaging infrastructure.

More generally, embodiments of the social messaging hub 100 include an application which enables a user (sometimes referred to herein as a subscriber) to perform SMS/MMS/EMS or voice texting activities using a data enabled device 26, such as an iPod Touch, iPad, portable e-Reader, a personal computer, a portable game player, a game console, a laptop, a television set or a netbook computer, all of which can connect to the Internet. Messaging is carried out bi-directionally between the data enabled device 26 (non-telephony device, smartphone or other data devices) and other SMS capable devices. The social messaging hub 100 is implemented without any add-ons, that is, without requiring the user to attach accessory electronic devices, and is implemented via a the social messaging hub 100 that maintains an Internet connected server that interfaces with certain wireless messaging facilities in the messaging infrastructure 20 to establish device-to-wireless communications. In different embodiments, the social messaging hub 100 may be a separate dedicated entity, or may be a service entity set up within a mobile service provider to service data enabled devices 26 of some of the provider's subscribers. Further, the social messaging hub 100 may provide applications for managing the address books, messages and account information of the user.

When the social messaging hub 100 is a separate message service center entity, the social messaging hub 100 operations may be incorporated by one or more mobile providers to extend their subscriber service capabilities and the provider entity may provide dedicated connections for affecting coordination between services, call logs and billing for the affected accounts.

Features of the social messaging hub 100 may be provided within, or as external hosting services communicating with an existing mobile network provider as a web based application using advanced web capabilities, and may be configured to handle all forms of messaging for the subscribers. Subscription/Unsubscription operations can be performed from a web client running on any data enabled device 26 that supports standard Internet browsers or from IP based applications.

FIG. 3 illustrates the architecture of one embodiment of the social messaging hub 100 for multiple messaging applications. The social messaging hub 100 includes an SMS provider 120 which provides the interface to the messaging infrastructure 20 and in particular in one embodiment to the SMSC 12, SMS aggregator 14 and (SMS-GW) 18. The SMS provider 120 is used to send and receive SMS/MMS/EMS messages respectively to and from: a mobile phone 29 through the cellular phone infrastructure 28 and a data enable device 26 shown here as laptop personal computer 32 and a smart phone 50. The social messaging hub 100 further includes a voice text processing engine 129 which is coupled to audio storage 127, the SMS provider 120 and the hub application 42.

The SMS provider 120 is interfaced to a web farm 150 having one or more servers 152a-152n (collectively referred to as web server 152). The servers 152a-152n store the SMS/MMS/EMS messages received and SMS/MMS/EMS messages to be delivered in conjunction with database server 125 and database 126. The servers 152a-152n also support a Hub application 42 which runs in conjunction an application 40 on data enabled device 26, here laptop 32 or smart phone 50. The web farm 150 is coupled to a database server 125 and corresponding database 126 which is used to store user information including the association between the assigned unique identifiers and data enabled device identifiers.

The social messaging hub 100 further includes a common message conversation queue which is interfaced to the database 126 and the message processing engine 128.

The database server 125 is connected to a message processing engine 128 which has an associated message processing database 136. Database server 125 in conjunction with database 126 primarily stores SMS messages and certain user information and it is used when interfacing to the messaging infrastructure 20. The components of the social messaging hub 100, in one embodiment, are developed in C, C++, JAVA® or other suitable programming language, and include web servers, such as Apache, Microsoft Internet Information Services platform (IIS) or other suitable server systems operating on a UNIX, Microsoft or other operating system platform to store and communicate messages to Internet devices. An exemplary software framework for the social messaging hub 100 includes the following:

The Hub application 42 on servers 152a-152n runs on a .Net framework and is hosted on a Microsoft IIS7 system on a windows 2008 server.

The database 126 is a relational database implemented in this embodiment using Microsoft SQL Server, and the message processing engine 128 is implemented as a COMET server, using a COMET engine (using .net framework). The SMS provider 120 is a C++ server application which interacts with the messaging infrastructure 20.

Implementations for specific social messaging entities and devices are schematically illustrated in FIG. 3 which, for purposes of discussion, reference the above-described software and other communications elements. It is understood, however, that the servers, interfaces and other hardware and software elements of each system may vary within a broad range, so long as the system is well integrated with its operative components and is configured to communicate effectively with the other messaging entities involved.

In operation, the SMS provider 120 determines from the destination of a received message where to route the message through the messaging infrastructure 20. The message may be routed through to one of the SMSC 12, the SMS aggregator 14 the (SMS-GW) 18 or other communications entity, operated by a mobile operator, aggregator or some other intermediary.

In operation a voice text from a subscriber's data enabled device is received by the hub application 42. The voice text includes a SMS destination identifier for the voice text. The voice text processing engine 129 processes the voice text and stores an attached received audio file 132 in audio storage 127. The voice text processing engine 129 then generates an SMS message with a link to the audio file of the voice text message audio file 132 and sends the message to the SMS provider 120. The SMS provider 120 provides the SMS message to a message service for delivery to a message recipient indicated by the SMS destination identifier.

The social messaging hub 100 consolidates message delivery into a common message conversation queue 130 and intermixes messages from other messaging services, including presence activity and geographic location data into the common message conversation queue 130. This consolidation, allows the social messaging hub 100 to enable personal replies to be threaded back to the user's social inbox so individual chat conversations can continue across multiple data enabled devices to provide multi-screen messaging.

When used to support multiple mobile network providers, advantageously, the social messaging hub 100 is configurable for each provider. It is understood that the various server functions of the social messaging hub 100 could be run on a single computer or multiple computers, storage could be provided by individual storage media or a storage area network.

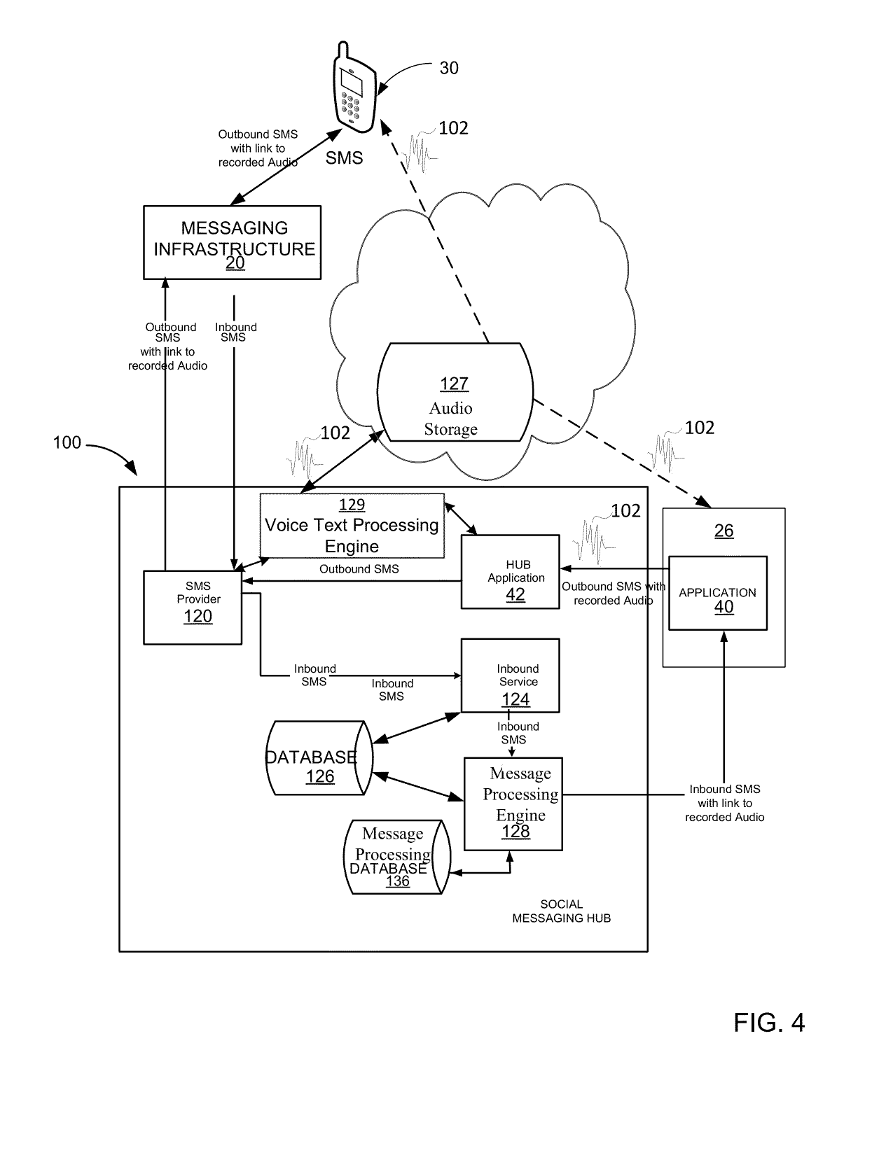

FIG. 4 illustrates further details of the text message-handling subsystem of the social messaging hub 100. A web client 38 operating on a data enabled device 26, connects to the social messaging hub 100. After user login and authentication, the Hub application 42 initiates a persistence connection (i.e., using the same Transmission Control Protocol (TCP) connection to send and receive multiple Hypertext Transfer Protocol (HTTP) requests/responses) to the message processing engine 128. As described above, the application 40 can be either a web client 38 (e.g., browser) or an app running on a data enabled device 26.

Outbound SMS/MMS messages are sent to the SMS provider 120 which in turn relays the message to the messaging infrastructure 20 (e.g., SMS Aggregator 14 or the SMSC 12). It is the responsibility, for example, of the SMSC 12 to send this message to the receiving party's (addressee's) device. Inbound SMS/MMS/EMS messages for a user of the social messaging hub 100 are received by the SMS provider 120 from the SMSC 12. The SMS provider 120 relays the message to an inbound service 124 which stores the message in the social messaging hub 100 database and also relays it to the message processing engine 128. The message processing engine 128 sends this message to the subscribed application 40 if an active session is available. If an active session is not available, the messages are stored in queue for delivery upon next login of the recipient.

In operation in one embodiment, a user composes and sends a voice text message by the following steps:

the User selects HeyWire App 40 from their mobile device 26;

the User selects to compose a new message;

the User inputs either by voice (if device has voice command functionality to access address book) or by typing the destination address (name-or-phone number);

the User selects button on message input screen for ‘Voice Text’ (instead of typing message);

the User records voice/audio message;

the User presses button to stop recording; and

the User presses SEND button to send Voice Text message via SMS.

The recorded audio file (e.g., MP3, WAV, etc.) is sent via IP connection to the HeyWire user's account on the HeyWire servers in the Cloud and stored for future retrieval. In some embodiments, Notification is triggered/sent to recipient of message, notifying them that there is an SMS message intended for them.

The recipient of the voice text uses the following steps to retrieve and listen to the voice text message:

the User opens SMS message;

the User is presented with a URL link in the SMS message that points to the file location of the intended audio Voice Text file on the HeyWire servers in the Cloud;

the User selects the URL;

the User's device retrieves/downloads the audio file from the HeyWire servers; and

the User's device upon sufficient buffering of audio file begins playing the audio file over the device's audio sound reproduction system (e.g.—speaker, earphone jack, etc.).

It is understood that the user can receive the voice text message on any SMS capable device in the world (i.e., the user does not need to be a subscriber of social messaging hub 100, for example, a HeyWire subscriber).

In one embodiment, where the user is a subscriber of social messaging hub 100, a reply to a voice text message is accomplished with the following steps:

the User hits REPLY button;

the User then has option to:
enter response via typing on keyboard of device; or
hit Voice Text button to record audio message.

the User hits SEND button to send reply.

In one embodiment, where the user is not a subscriber of social messaging hub 100, a reply to a voice text message is accomplished with the following steps:

reply to Voice Text message (Non-HeyWire subscriber);
the User hits REPLY button in SMS client app on device;
the User enters response via typing on keyboard of device; and
the User hits SEND button to send reply.

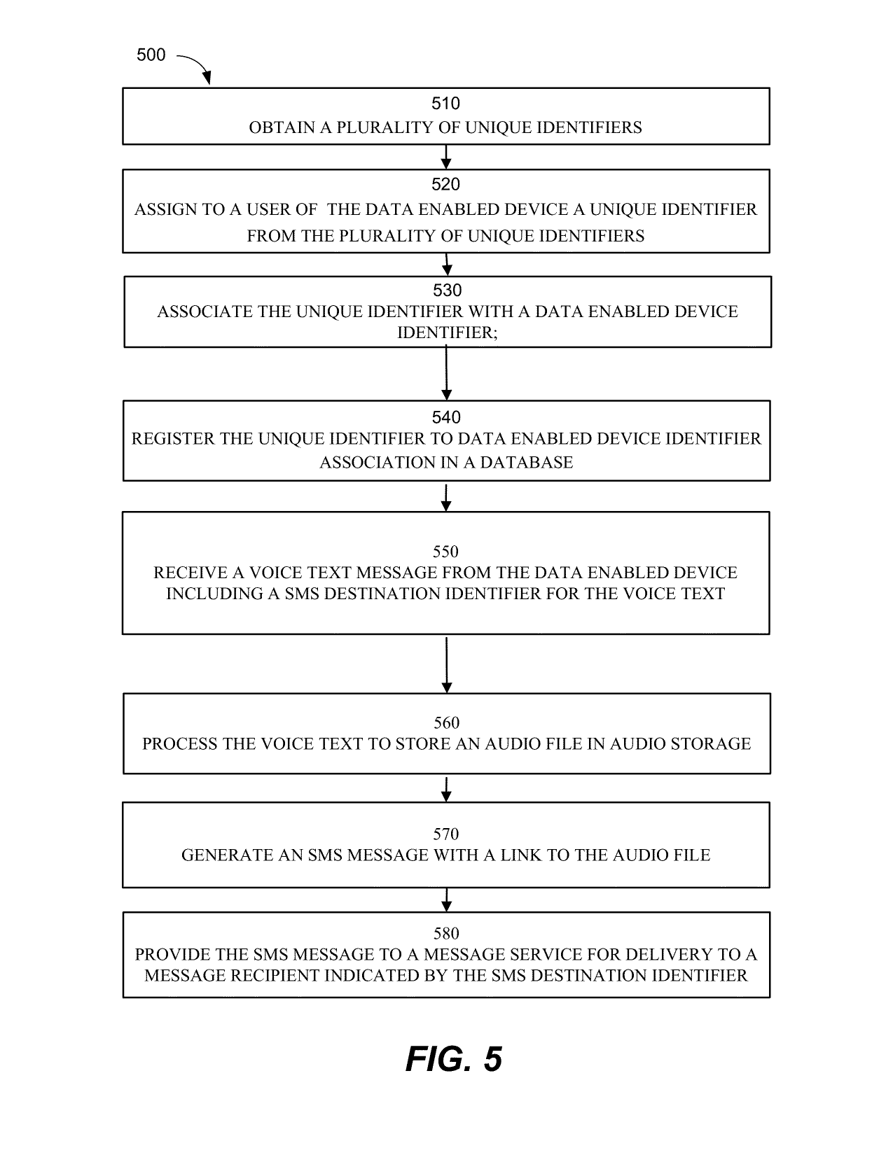

In FIG. 5, flowchart 500 diagrams the overall process of the transmission and reception of SMS voice text messages facilitated by the social messaging hub 100. In step 510 the social messaging hub 100, obtains a plurality of unique identifiers. In step 520, a user of the data enabled device 26 is assigned a unique identifier from the plurality of unique identifiers. In step 530, the unique identifier is associated with a data enabled device identifier, and in step 540, the unique identifier to data enabled device identifier association is registered in the database 126.

In step 550, a voice text is received from the data enabled device including a SMS destination identifier for the voice text. In step 560, the voice text is processed to store an audio file in audio storage 127. In step 570, an SMS message is generated with a link to the audio file of the voice text message audio file 132, and finally in step 580, the SMS message is provided to a message service in the messaging infrastructure 20 for delivery to a message recipient indicated by the SMS destination identifier. In one embodiment, the voice text is recorded by taking advantage of the mobile device's inherent audio capabilities (e.g., microphone, WAV/MP3 file formatting, etc.) In one embodiment, a time limit for the voice text is set to a predetermined time interval (e.g., thirty seconds or two minutes), but much larger or smaller time intervals can be used depending on limitations of the mobile device 137.

Now referring to FIGS. 6A-6I, user interface screens 600-608 allow the creation and transmission of a voice text. Screen 600 shows an SMS message from a social networking service (e.g., Twitter) in response to initiating an account by, for example, texting the word START to the short code for the social networking service. The screen 600 also includes a compose button 604, which when pressed displays the New Message screen 601. Screen 601 includes an alphabetic keyboard 618 and numeric keyboard selector 614, an SMS text entry text box 612, a send button 616 and an address entry text box 610. Screen 601, includes a numeric keypad 620 selected by numeric keyboard selector 614.

Screen 603 shows a short code entry 630, here short code 40404 for Twitter, entered into the address entry text box 610. Screen 604 shows a text message 640 entered into the SMS text entry text box 612. At this point, the user can select the send button 642 to initiate the message sending process. After pressing the send button 642 the user is presented several options on screen 605. These button options include Paste Photo 652, Take Photo 653, Browse Photos 654 and Voice Text 655 (voice text selection button). The user can cancel these options by pressing the Cancel button 656. Here, the user selects Voice Text 655 and the application displays a voice text recording screen 606.

The voice text recording screen 606 includes a voice text length indicator 661, a voice text progress indicator 662, and a voice text time limit 663. In one embodiment the time limit is set at two minutes, but this time limit is adjustable and can be determined by a number of factors, including but not limited to, the available storage allocated to a user or other external requirements associated with the address of the voice text. The voice text recording screen 606 further includes a stop button 664 and a cancel button 665. Once the voice text is recorded, screen 607 displays the recorded voice text length 672. the user then has the option to send the voice text using the Send button 674, to play the voice text using the Play button 676, to re-record the voice text using the Re-do button 677, or cancel the voice text using the Cancel button 675.

Screen 608 shows a message log of HeyWire Voice Texting including a sent voice text with an accompanying message. The accompanying message “‘Send voice text to Twitter demo” is displayed in text box 683, and an avatar 684 represents the recorded audio voice text message. Here, the destination was recorded as a Twitter user. Using the avatar 684, the user can replay the voice text.

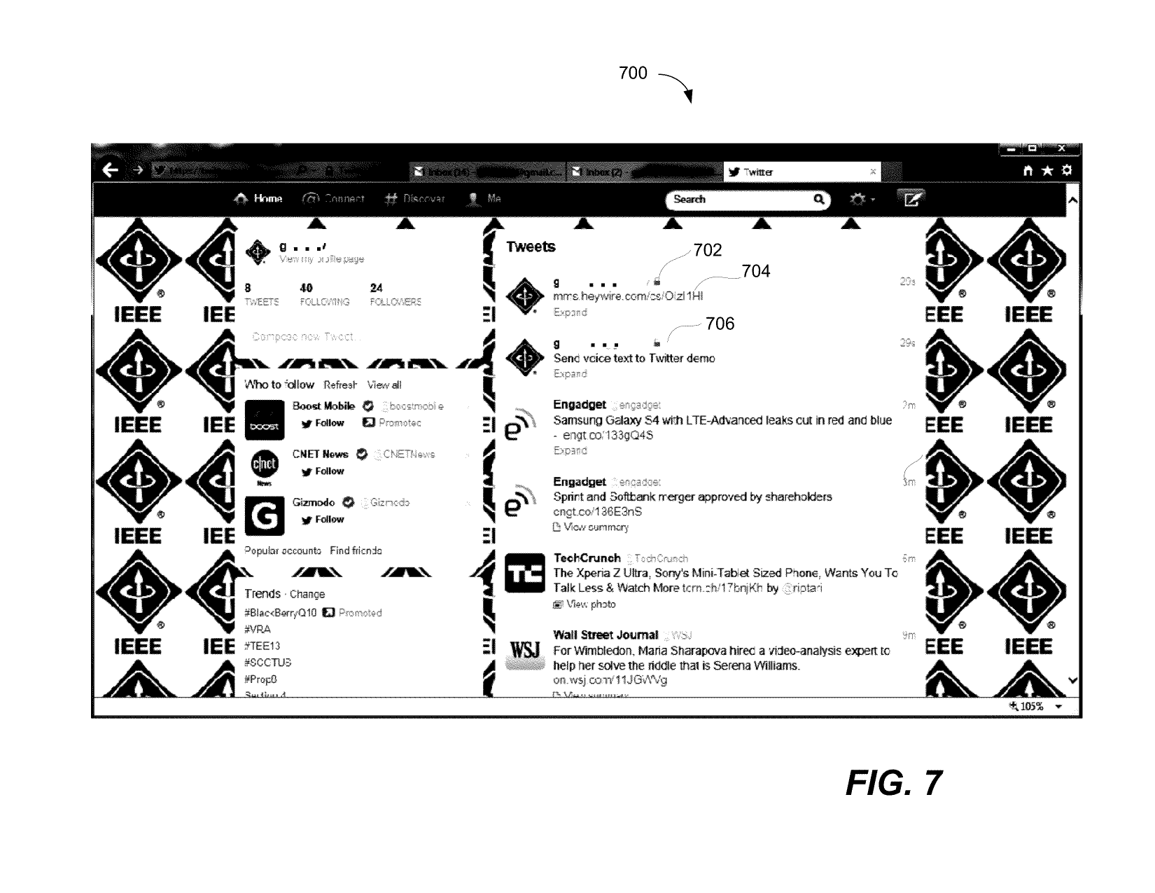

Now referring to FIG. 7, an exemplary home screen for a social networking service, here a microblogging service, indicates SMS messages 702 and 706 which have been received by the microblogging service as a result of the voice text being sent as described above. In particular, SMS message 702 includes a link 704 to an audio file of the voice text. In some embodiments, the voice text is played by clicking on the link or the tweet in this example. Any “followers” of the recipient on the microblogging service will see the post of the link for the voice text and are also be able to play the audio file recording of the voice text.

While configurations of the system and method have been particularly shown and described with references to configurations thereof, it will be understood by those skilled in the art that various changes in form and details may be made therein without departing from the scope of the invention. As an example, the order of processing steps in the flow charts is not limited to the order shown herein. Accordingly, the present invention is not limited by the example configurations provided above.

What is claimed is:

1. A method for voice texting over Short Message Service/Multimedia Messaging Service/Enhanced Messaging Service (SMS/MMS/EMS) communications comprising:
obtaining a plurality of unique identifiers;
assigning to a user of a data enabled device a unique identifier from the plurality of unique identifiers;
associating the unique identifier with a data enabled device identifier;
registering the unique identifier to data enabled device identifier association in a database;
receiving a voice text from the data enabled device including a SMS destination identifier for the voice text;
processing the voice text to store an audio file in audio storage;
generating an SMS message with a link to the audio file;
providing the SMS message to a message service for delivery to a message recipient indicated by the SMS destination identifier.

2. The method of claim 1 further comprising generating a second SMS message with text provided by a user.

3. The method of claim 1 further comprising providing the SMS message with a link to the audio file to an online social networking service for delivery to at least one subscriber of the online social networking service.

4. The method of claim 1 further comprising providing the SMS message with a link to the audio file to an online microblogging service for delivery to at least one subscriber of the online microblogging service.

5. The method of claim 1 further comprising providing the SMS message with a link to the audio file to an online messaging service for delivery to at least one subscriber of the online messaging service.

6. The method of claim 1 further comprising providing the SMS message with a link to the audio file to an online discussion forum service for delivery to at least one subscriber of the online discussion forum service.

7. The method of claim 1, wherein the audio storage comprises a cloud storage system.

8. A social messaging hub for voice texting over Short Message Service/Multimedia Messaging Service/Enhanced Messaging Service (SMS/MMS/EMS) communications comprising:
a hub application operating on a web server;
a voice text processing engine coupled to the hub application;
an audio storage subsystem coupled to the voice text processing engine; and
an SMS provider coupled to the voice text processing engine and to a global SMS infrastructure.

9. The social messaging hub of claim 8, wherein the audio storage subsystem comprises a cloud storage system.

10. A social messaging application for voice texting over Short Message Service/Multimedia Messaging Service/Enhanced Messaging Service (SMS/MMS/EMS) communications comprising:
a user interface comprising:
a voice text selection button;
a voice text recording screen;
an interface to an audio storage subsystem for uploading an audio file of the voice text to the external storage sub-system.

11. The social messaging application of claim 10 wherein the audio storage subsystem comprises a cloud storage system.
